(19) United States
(12) Patent Application Publication
(10) Pub. No.: US 2013/0163295 A1
(43) Pub. Date: Jun. 27, 2013

(54) POWER SUPPLY CONVERTER WITH A PRE-REGULATOR

(71) Applicants: Bing LU, Manchester, NH (US); Isaac COHEN, Dix Hills, NY (US)

(72) Inventors: Bing LU, Manchester, NH (US); Isaac COHEN, Dix Hills, NY (US)

(21) Appl. No.: 13/337,660

(22) Filed: Dec. 27, 2011

(51) Int. Cl. H02M 1/12

(52) U.S. Cl. 363/44

(57) ABSTRACT

A power supply converter with a pre-regulator is provided. In one embodiment, the power supply converter comprises a rectifier that receives an AC input voltage and provides a rectified AC input voltage, a filter that receives the rectified AC input voltage and provides a filtered DC input voltage and a pre-regulator that connects the rectified AC input voltage for allowing for providing current and voltage to the filter from the rectified AC input voltage upon a measurement that indicates that the AC input voltage or the rectified AC input voltage crosses a predetermined turn on threshold.

### TECHNICAL FIELD

The present invention relates generally to electronic circuits, and specifically to a power supply converter with a pre-regulator.

### BACKGROUND

Certain power supply converters (e.g., AC-DC converters) need to accommodate substantially wide input voltage ranges to cover different situations when being employed in a given application. For example, smart meters are powered by power supply converters that rectify a 120 VAC input voltage to a DC input voltage that powers a DC-DC converter to provide a 5-28 VDC output voltage to components of a smart meter. However, in certain situations the DC input voltage can rise to a substantially high DC input voltage, such as 1000 volts due to an error such as a voltage spike or technician wiring error. Therefore, the power converter needs to be designed to handle these high DC input voltage, which requires larger and more expensive components that would be required to handle the DC input voltage at normal voltage levels.

FIG. 1 illustrates an exemplary prior art power supply converter 10 that is designed to accommodate substantially wide input voltage ranges. The power supply converter 10 includes a rectifier 12 that receives an AC input signal and provides a rectified AC input voltage (RECT ACIN) to a filter 20 that provides a filtered DC input voltage (DCIN) to a DC-DC converter 22. The filter 20 is formed of series connected capacitors C1 and C2 and series connected resistors R1 and R2. Capacitors C1 and C2 are required to be substantially large due to the fact that the power converter design needs to accommodate a substantially large rectified AC input voltage and further due to the fact that the capacitors are designed to be in series, which reduces their total capacitance. R1 and R2 are required to achieve voltage balancing between C1 and C2. At high voltages, the power loss on R1 and R2 is significant. In the present example, the DC-DC converter 22 is a fly-back converter that includes a controller 14 that switches on an off both a high-side switch Q1 and a low-side switch Q2 to drive a transformer T1. The high-side switch Q1 and the low-side switch Q2 are arranged in a cascode configuration, such that turning on of the low-side switch Q2 causes the high-side switch Q1 to turn on and turning off of the low-side switch Q2 causes the turning off of the high-side switch. The transformer T1 includes windings W1, W2 and W3 to provide a DC voltage through a diode D1 to an output circuit 16 that provides a regulated DC output voltage (VOUT). The regulated DC output voltage is provided to a feedback circuit 18 to provide an error signal to the controller 14. Again, due to the fact that the controller, the switching transistors Q1 and Q2, the transformer T1 and diode D1 are designed to accommodate a substantially large rectified AC input voltage, a substantially more complicated, larger and more expensive component design is required compare to one that is designed to handle only normal rectified AC input voltages.

### SUMMARY

In accordance with an aspect of the invention, a power supply converter is provided. The power supply converter comprises a rectifier that receives an AC input voltage and provides a rectified AC input voltage, a filter that receives the rectified AC input voltage and provides a filtered DC input voltage and a pre-regulator that connects the rectified AC input voltage for allowing for providing current and voltage to the filter from the rectified AC input voltage upon a measurement that indicates that the AC input voltage or the rectified AC input voltage crosses a predetermined turn on threshold.

In accordance with another aspect of the present invention, a power supply converter is provided that comprises a rectifier that receives an AC input voltage and provides a rectified AC input voltage, a capacitor that receives the rectified AC input voltage and provides a filtered DC input voltage, and a DC-DC converter that receives the filtered DC input voltage and provides a regulated DC output voltage. The power supply converter also comprises a pre-regulator that connects the rectified AC input voltage to allow for providing current and voltage to the capacitor and the DC-DC converter from the rectified AC input voltage upon the rectified AC input voltage crossing a predetermined turn on threshold and disconnects the rectified AC input voltage from allowing for providing current and voltage to the capacitor and the DC-DC converter from the rectified AC input voltage upon the rectified AC input voltage exceeding a predetermined turn off threshold.

In accordance with a further aspect of the invention, a method for limiting a rectified AC input voltage in a power supply converter is provided. The method comprises providing a rectified AC input voltage to a filter to provide a filtered DC input voltage to a DC-DC converter, disconnecting the rectified AC input voltage from allowing for providing current and voltage to the filter upon the rectified AC input voltage exceeding a predetermined turn off threshold, and connecting the rectified AC input voltage to providing current and voltage to the filter upon the rectified AC input voltage crossing a predetermined turn on threshold.

### BRIEF DESCRIPTION OF THE DRAWINGS

FIG. 1 illustrates a schematic block diagram of an exemplary prior art power supply converter that is designed to accommodate substantially wide input voltage ranges.

FIG. 2 illustrates a schematic block diagram of a power supply converter in accordance with an aspect of the invention.

FIG. 3 illustrates a schematic block diagram of another power supply converter in accordance with an aspect of the present invention.

FIG. 4 illustrates a timing diagram of operation of the power supply converter with the pre-regulator in accordance with an aspect of the present invention.

FIG. 5 illustrates a method for limiting a rectified AC input voltage in a power supply converter in accordance with an aspect of the invention.

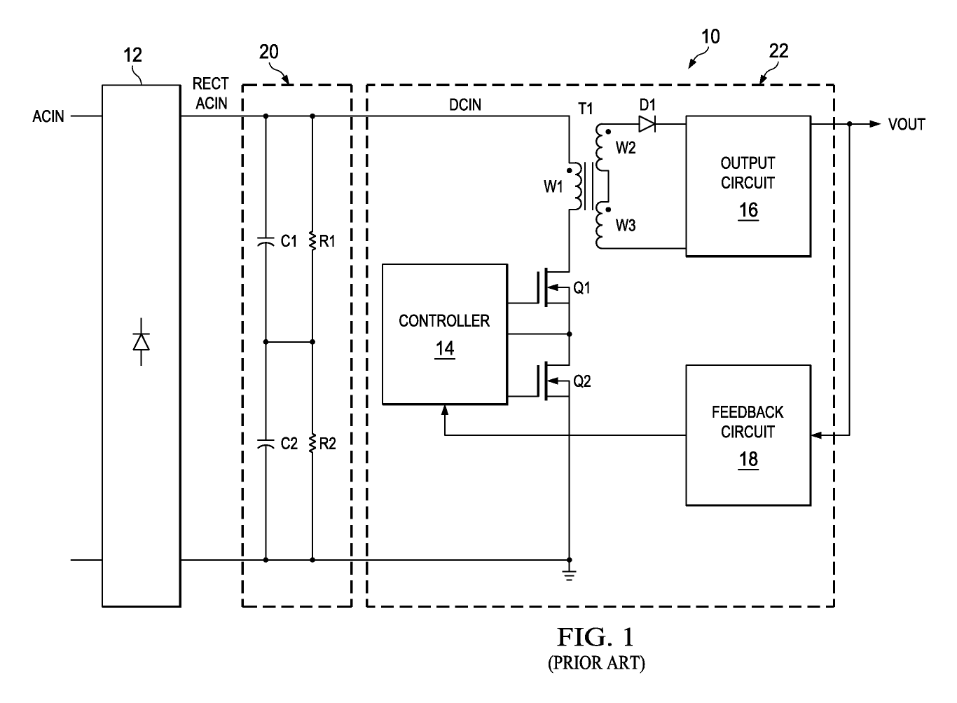

### DETAILED DESCRIPTION

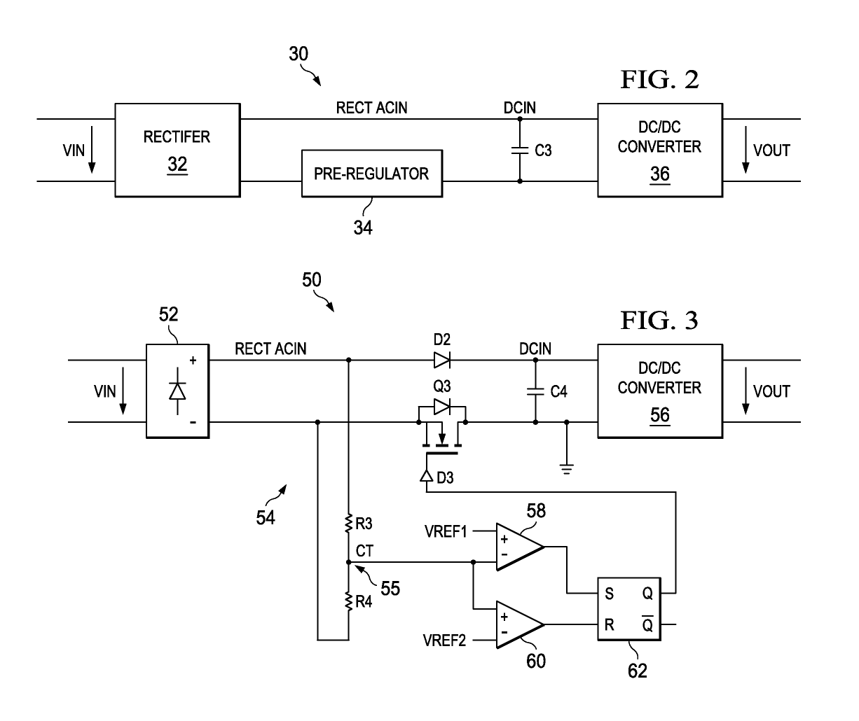

FIG. 2 illustrates an example of a power supply converter 30 in accordance with an aspect of the present invention. The power supply converter 30 includes a rectifier 32 that receives an AC input signal (VIN) and provides a rectified AC input voltage (RECT ACIN) to a filter. The filter smoothes the rectified AC input voltage and provides a filtered unregulated DC input voltage (DCIN) to a DC-DC converter 36. The DC-DC converter 36 converts the filtered unregulated DC input voltage (DCIN) into a regulated DC output voltage (VOUT). The filter is in the form of a capacitor C3 that stores charge to produce the filtered unregulated DC input voltage (DCIN). A pre-regulator 34 is coupled between the rectifier 32 and the DC-DC converter 36 and blocks the rectified AC input voltage when the rectified AC input voltage and/or the AC input voltage exceeds a threshold that is above a maximum desired AC input voltage and/or rectified AC input voltage. In this manner, the pre-regulator 34 can limit the DC input voltage that is provided to the DC-DC converter 36 of the power supply converter 30 to a maximum desired DC input voltage when the pre-regulator 36 senses an AC input voltage or rectified AC input voltage greater than the maximum desired DC input voltage. It is to be appreciated that a variety of measurement techniques could be employed to determine AC information for detecting a turn on and turn off threshold.

The pre-regulator 36 can allow the rectified AC input voltage to provide charge to the capacitor C3 when the AC input voltage and/or the rectified AC input voltage crosses a predetermined turn on threshold (e.g., zero crossing point). It is to be appreciated that the rectified AC input voltage provides charge to the capacitor C3 and power to the DC-DC converter 36 during the half cycles of the rectified AC input voltage that falls below the maximum desired DC rectified input voltage and is greater than the filtered DC input voltage to the DC-DC converter 36. Therefore, the design and components of the power supply converter 30 and the DC-DC converter 36 can be of reduced cost, reduced size and reduced complexity than compared to a conventional power supply converter that is designed to handle rectified AC input voltages substantially higher than the maximum desired rectified AC input voltage.

FIG. 3 illustrates an example of another power supply converter 50 in accordance with an aspect of the present invention. The power supply converter 50 includes a rectifier 52 that receives an AC input signal (VIN) and provides a rectified AC input voltage (RECT ACIN) to a filter (C4) that provides a filtered unregulated DC input voltage (DCIN) to a DC-DC converter 56. The DC-DC converter 56 converts the filtered unregulated DC input voltage to a regulated DC output voltage (VOUT). The filter is in the form of a capacitor C4 that stores charge to produce the filtered unregulated DC input voltage. A pre-regulator 54 comprises a MOSFET switch Q3 that is coupled to return terminals of the rectifier 52 and the capacitor C4 and DC-DC converter 56. The MOSFET switch Q3 is in either a closed state in which the rectified AC input voltage is allowing for supplying current and voltage to the capacitor C4 and the DC-DC converter 56, or in an open state in which the rectified AC input voltage is not allowing for supplying current and voltage to the capacitor C4 and the DC-DC converter 56. Therefore, current and voltage from the capacitor C4 is provided to the DC-DC converter 56.

The pre-regulator 54 also includes a voltage divider 55 comprised of series coupled resistors R3 and R4, which are coupled between a positive and negative output terminal (return terminal) of the rectifier 52. A common terminal (CT) of the voltage divider 55 provides a reduced voltage measurement of the rectified AC input voltage. The reduced voltage measurement from the common terminal is provided to a negative input terminal of a first comparator 58 and a negative input terminal of a second comparator 60. A first reference voltage (VREF1) is provided to a positive input terminal of the first comparator 58 and represents a rectified AC input turn on voltage threshold which can be substantially about a zero crossing point (e.g., about 10-20 volts) of the rectified AC input voltage. A second reference voltage (VREF2) is provided to a positive input terminal of the second comparator 60 and represents a turn off voltage threshold, which is at a maximum desired rectified AC input voltage (e.g., 400 volts).

The output of the first comparator 58 is provided to a set input of an R-S latch 62 and sets the latch when the rectified AC input voltage crosses the turn on threshold (e.g., about a zero crossing point (e.g., about 10-20 volts)). The output of the latch 62 is connected to the MOSFET switch Q3 through a diode D3 and causes the MOSFET switch Q3 to close when the output of the latch is set, which connects the rectified AC input voltage to allow for providing current and voltage to the capacitor C4 and the DC-DC converter 56. The output of the second comparator 60 is provided to a reset input of the R-S latch 62 and resets the latch 62 when the rectified AC input voltage reaches a turn off threshold (e.g., above the maximum desired rectified AC input voltage). The resetting of the output of the latch 62 causes the MOSFET switch Q3 to open, which disconnects the rectified AC input voltage from allowing for providing current and voltage to the capacitor C4 and the DC-DC converter 56. Since the rectified AC input voltage is limited to a maximum desired rectified AC input voltage, a single small capacitor C4 can be employed and the design and other components of the power supply converter 50 and the DC-DC converter 56 can be of reduced cost, reduced size and reduced complexity compared to a conventional power supply converter that is designed to handle DC input voltages substantially higher than the maximum desired rectified AC input voltage.

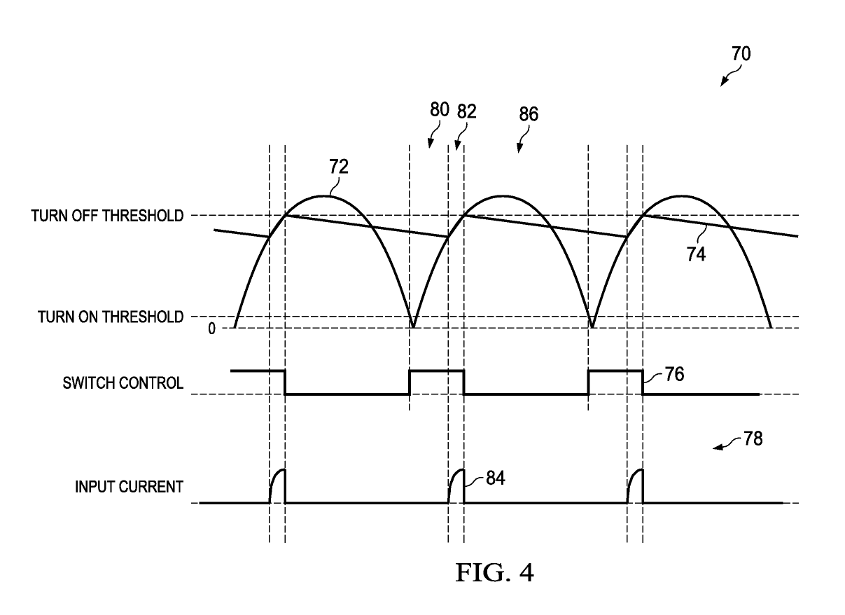

FIG. 4 illustrates a timing diagram 70 of operation of the power supply converter 50 with the pre-regulator 54 in accordance with an aspect of the present invention. The timing diagram 70 illustrates a rectified AC input voltage waveform 72 output from the rectifier 52, a filtered DC input voltage waveform 74 input to the DC-DC converter 56, a switch control waveform 76 from the RS latch 62 and an input current waveform 78 from the AC input source (VIN) and the rectifier 52.

As illustrated in the timing diagram 50, the rectified AC input voltage waveform 72 is comprised of a plurality of positive half cycles. As is shown in the rectified AC input voltage waveform 72, at the end of the first half cycle shown, the rectified AC input voltage crosses the turn on threshold causing the RS latch 62 to set, as illustrated in the switch control waveform 76 and close the MOSFET switch Q3 allowing the rectified AC input voltage to provide voltage and current to the capacitor C4 and the DC-DC converter 56. However, the rectified AC input voltage does not provide voltage and current to the capacitor C4 and the DC-DC converter 56 during a first on time period 80, since the rectified AC output voltage does not exceed the filtered DC input voltage to the DC-DC converter 56. During the first on time period 80, the capacitor C4 provides voltage and current to the DC-DC converter 56. During a second on time period 82, the rectified AC input voltage does provide voltage and current to the capacitor C4 and the DC-DC converter 56, since the rectified AC input voltage does exceed the filtered DC input voltage to the DC-DC converter 56. The capacitor C4 then begins charging as illustrated in the positive slope of the DC input voltage during the second on time period 82 and a positive inrush current pulse 84 is provided as illustrated in the input current waveform 78. Once the DC rectified input voltage crosses a turn off threshold, the RS latch 62 is reset as illustrated in the switch control waveform 76 and opens the MOSFET switch Q3 preventing the rectified AC input voltage from allowing for providing voltage and current to the capacitor C4 and the DC-DC converter 56 during an off time period 86. The above described cycle then continuously repeats for subsequent half cycles of the DC rectified input voltage waveform 72.

It is to be appreciated that a variety of measuring techniques besides the one illustrated in FIGS. 3-4 could be employed to determine a turn on point (e.g., zero crossing point) or a turn-off point (maximum AC input voltage or maximum rectified AC input voltage). For example, a differential amplifier can be coupled to terminals of the AC input voltage or the rectified AC input voltage to determine if the AC input voltage or rectified AC input voltage has crossed a turn on point or a turn-off point. The turning on point at the zero crossing allows facilitates the avoidance of high peak input current, large loss on capacitor charging and complex control techniques.

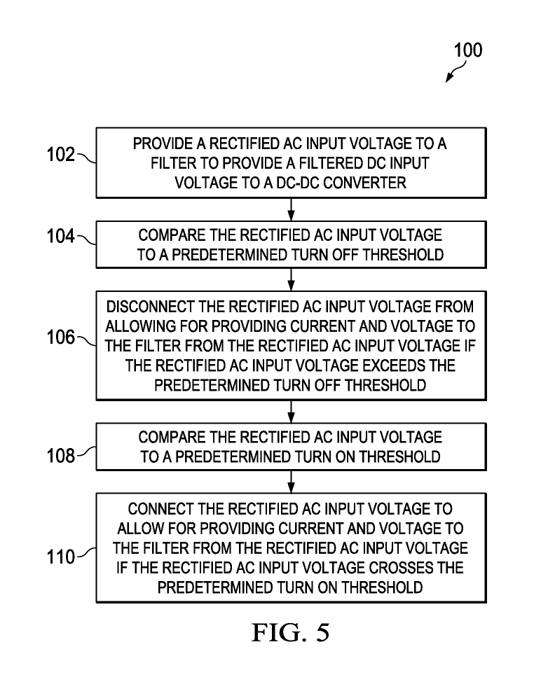

In view of the foregoing structural and functional features described above, certain methods will be better appreciated with reference to FIG. 5. It is to be understood and appreciated that the illustrated actions, in other embodiments, may occur in different orders and/or concurrently with other actions. Moreover, not all illustrated features may be required to implement a method.

FIG. 5 illustrates a method 100 for limiting a rectified AC input voltage in a power supply converter in accordance with an aspect of the invention. The method 100 begins at 102 where a rectified AC input voltage is provided to a filter to provide a filtered DC input voltage to a DC-DC converter. At 104, the rectified AC input voltage is compared to a predetermined turn off threshold. At 106, the rectified AC input voltage is disconnected from allowing for providing current and voltage to the filter from the rectified AC input voltage if the rectified AC input voltage exceeds the predetermined turn off threshold. At 108, the rectified AC input voltage is compared to a predetermined turn on threshold. At 110, the rectified AC input voltage is connected to allow for providing current and voltage to the filter from the rectified AC input voltage if the rectified AC input voltage crosses the predetermined turn on threshold.

What have been described above are examples of the invention. It is, of course, not possible to describe every conceivable combination of components or method for purposes of describing the invention, but one of ordinary skill in the art will recognize that many further combinations and permutations of the invention are possible. Accordingly, the invention is intended to embrace all such alterations, modifications, and variations that fall within the scope of this application, including the appended claims.

What is claimed is:

1. A power supply converter comprising:
a rectifier that receives an AC input voltage and provides a rectified AC input voltage;
a filter that receives the rectified AC input voltage and provides a filtered DC input voltage; and
a pre-regulator that connects the rectified AC input voltage for allowing for providing current and voltage to the filter from the rectified AC input voltage upon a measurement that indicates that the AC input voltage or the rectified AC input voltage crosses a predetermined turn on threshold.

2. The converter of claim 1, further comprising a DC-DC converter that receives the filtered DC input voltage and provides a regulated DC output voltage, the pre-regulator connecting the rectified AC input voltage for providing current and voltage to the DC-DC converter upon the AC input voltage or rectified AC input voltage crosses the predetermined turn on threshold.

3. The converter of claim 1, wherein the predetermined turn on threshold is about a zero crossing point.

4. The converter of claim 1, wherein the pre-regulator disconnects the rectified AC input voltage from providing current and voltage to the filter upon the rectified AC input voltage or the AC input voltage exceeding a predetermined turn off threshold.

5. The converter of claim 4, wherein the predetermined turn on threshold is about a zero crossing point of the rectified AC input voltage or AC input voltage and the predetermined turn off threshold is at a maximum desired rectified AC input voltage or AC input voltage.

6. The converter of claim 5, wherein the rectified AC input voltage only provides current and voltage to the filter upon the rectified AC input voltage crossing the predetermined turn on threshold and exceeding the filtered DC input voltage.

7. The converter of claim 1, the pre-regulator comprising a switch that closes upon the rectified AC input voltage crossing the predetermined turn on threshold and opens upon the rectified AC input voltage exceeding a predetermined turn off threshold.

8. The converter of claim 7, the pre-regulator further comprising a first comparator that compares a reduced voltage measurement of the rectified AC input voltage to a first reference voltage associated with the predetermined turn off threshold and a second comparator that compares the reduced voltage measurement of the rectified AC input voltage to a second reference voltage associated with the predetermined turn on threshold, the output state of the first and second comparators determining whether the switch is in an open state or a closed state.

9. The converter of claim 8, the pre-regulator further comprising a latch having a set input coupled to an output of the first comparator and a reset input coupled to an output of the second comparator, such that the output of the latch closes the switch upon the rectified AC input voltage crossing the predetermined turn on threshold and opens the switch upon the rectified AC input voltage exceeding the predetermined turn off threshold.

10. A power supply converter comprising:
a rectifier that receives an AC input voltage and provides a rectified AC input voltage;
a capacitor that receives the rectified AC input voltage and provides a filtered DC input voltage;
a DC-DC converter that receives the filtered DC input voltage and provides a regulated DC output voltage; and
a pre-regulator that connects the rectified AC input voltage to allow for providing current and voltage to the capacitor and the DC-DC converter from the rectified AC input voltage upon the rectified AC input voltage crossing a predetermined turn on threshold and disconnects the rectified AC input voltage from allowing for providing current and voltage to the capacitor and the DC-DC converter from the rectified AC input voltage upon the rectified AC input voltage exceeding a predetermined turn off threshold.

11. The converter of claim 10, wherein the capacitor provides current and voltage to the DC-DC converter when the rectified AC input voltage is disconnected.

12. The converter of claim 10, wherein the predetermined turn on threshold is about a zero crossing point of the rectified AC input voltage and the predetermined turn off threshold is at a maximum desired rectified AC input voltage.

13. The converter of claim 10, wherein the rectified AC input voltage provides current and voltage to the capacitor and the DC-DC converter upon the rectified AC input voltage crossing a predetermined turn on threshold and exceeding the filtered DC input voltage.

14. The converter of claim 10, the pre-regulator comprising a switch coupled between return terminals of the rectifier and the capacitor, the switch closes upon the rectified AC input voltage crossing the predetermined turn on threshold and opens upon the rectified AC input voltage exceeding the predetermined turn off threshold.

15. The converter of claim 14, the pre-regulator further comprising a first comparator that compares a reduced voltage measurement of the rectified AC input voltage to a first reference voltage associated with the predetermined turn off threshold and a second comparator that compares the reduced voltage measurement of the rectified AC input voltage to a second reference voltage associated with the predetermined turn on threshold, the output state of the first and second comparators determining whether the switch is in an open state or a closed state.

16. The converter of claim 15, the pre-regulator further comprising a latch having a set input coupled to an output of the first comparator and a reset input coupled to an output of the second comparator, such that the output of the latch closes the switch upon the rectified AC input voltage crossing a predetermined turn on threshold and opens the switch upon the rectified AC input voltage exceeding the predetermined turn off threshold.

17. A method for limiting a rectified AC input voltage in a power supply converter, the method comprising:
providing a rectified AC input voltage to a filter to provide a filtered DC input voltage to a DC-DC converter;
disconnecting the rectified AC input voltage from allowing for providing current and voltage to the filter upon the rectified AC input voltage exceeding a predetermined turn off threshold; and
connecting the rectified AC input voltage to providing current and voltage to the filter upon the rectified AC input voltage crossing a predetermined turn on threshold.

18. The method of claim 17, wherein the predetermined turn on threshold is about a zero crossing point of the rectified AC input voltage.

19. The method of claim 18, wherein the predetermined turn off threshold is at a maximum desired rectified AC input voltage.

20. The method of claim 19, wherein the rectified AC input voltage provides current and voltage to the filter upon the rectified AC input voltage crossing the predetermined turn on threshold and exceeding the filtered DC input voltage.
